(19) United States
(12) Patent Application Publication
(10) Pub. No.: US 2025/0173436 A1
(43) Pub. Date: May 29, 2025

(54) CONTEXT-BASED CYBERATTACK SIGNATURE GENERATION WITH LARGE LANGUAGE MODELS

(71) Applicant: Palo Alto Networks, Inc., Santa Clara, CA (US)

(72) Inventors: Haozhe Zhang, San Jose, CA (US); Qi Deng, Sunnyvale, CA (US); Hui Gao, Sunnyvale, CA (US); Chien-Hua Lu, San Jose, CA (US); Yanhui Jia, San Jose, CA (US)

(21) Appl. No.: 18/521,979

(22) Filed: Nov. 28, 2023

(51) Int. Cl. G06F 21/56

(52) U.S. Cl. CPC G06F 21/56; G06F 2221/034

(57) ABSTRACT

A context-based cyberattack signature generation system (“signature generation system”) disclosed herein comprises a signature prompt schema for generating prompts to a language model that generates cyberattack signatures. The signature prompt schema comprises a description of syntax for the cyberattack signatures and descriptions of case knowledge and domain knowledge for a type of cyberattack corresponding to a cyberattack signature. The signature generation system tests cyberattack signatures generated with the signature prompt schema against minimum signature conditions and traffic with ground-truth malicious/benign labels. Once the signature prompt schema passes the tests, the signature generation system deploys the tested signature prompt schema in combination with the language model for cyberattack signature generation.

### BACKGROUND

The disclosure generally relates to computing arrangements based on computational models (e.g., CPC G06N) and electrical digital data processing related to handling natural language data (e.g., CPC G06F 40/00).

Dialogue systems are sometimes referred to as chatbots, conversation agents, or digital assistants. While the different terms may correspond to different types of dialogues systems, the commonality is that they provide a conversational user interface. Some functionality of dialogue systems includes intent classification and entity extraction. Dialogue systems have been designed as rule-based dialogue systems, and many commercially deployed dialogue systems are rule-based. However, statistical data-driven dialogue systems that use machine learning have become a more popular approach. A statistical data-driven dialogue system has components that can include a natural language understanding (NLU) component, a dialogue manager, and a natural language generator. Some statistical data-driven dialogue systems use language models or large language models. A language model is a probability distribution over sequences of words or tokens. A large language model (LLM) is “large” because the training parameters are typically in the billions. Neural language model refers to a language model that uses a neural network(s), which includes Transformer-based LLMs.

### BRIEF DESCRIPTION OF THE DRAWINGS

Embodiments of the disclosure may be better understood by referencing the accompanying drawings.

FIG. 1 is a schematic diagram of a context-based cyberattack signature generation system with a language model and a regression/traffic testing module.

FIG. 2 is a diagram of an example signature prompt schema and example minimum signature conditions for a test case cyberattack signature.

FIG. 3 is a flowchart of example operations for engineering and deploying a signature prompt schema for cyberattack signature generation in combination with a language model.

FIG. 4 is a flowchart of example operations for testing signatures obtained from prompting a language model with generated prompts.

FIG. 5 depicts an example computer system with a context-based cyberattack signature generation system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

In typical deployments of cybersecurity appliances, cyberattack signatures are continuously generated and updated to respond to an increasingly complex attack plane. The number and variety of cyberattack signatures is exorbitant for manual signature generation by domain-level experts. Moreover, existing cyberattack signatures often become obsolete for their intended purpose as types of cyberattacks evolve. As such, cyberattack signatures need to be periodically updated, which adds to the labor cost of manual signature generation. A context-based cyberattack signature generation system (“signature generation system”) disclosed herein leverages natural language comprehension afforded by LLMs for cyberattack signature generation. The LLMs receive prompts that include case knowledge (e.g., vulnerability reports, blogs, proof of concept (PoC) code, exploit scripts, etc.) as well as domain knowledge (i.e., descriptions of how to understand case knowledge) to generate cyberattack signatures in response. LLMs have a more sophisticated understanding of cyberattacks than generic, regular expression-based methods, and the generated cyberattack signatures can detect variants of cyberattacks that may be missed by these regular expression-based methods. “Context” refers to context of cyberattacks detected by signatures that is incorporated into the domain knowledge such as protocols in the Internet protocol suite and fields in protocol data units (PDUs) targeted by cyberattacks.

At a first stage, the signature generation system engineers a signature prompt schema to generate prompts to a LLM that incorporate case knowledge and domain knowledge for types of cyberattacks corresponding to each signature. The signature prompt schema additionally comprises a description of syntax for signatures. A signature testing module performs validation testing and traffic testing of prompts generated with the signature prompt schema by first generating prompts from test case/domain knowledge, prompting the LLM with the generated prompts to generate signatures, and then testing the generated signatures according to various criteria. Each generated signature corresponds to a separate test case for which validation testing and traffic testing is applied. Validation testing the generated signatures comprises determining whether pattern/context pairs that should be present for signatures of the corresponding test cases are present in the generated signatures. Each test case has minimum signature conditions that define pattern/context pairs required in each generated signature to pass validation testing. Traffic testing comprises deploying the generated signatures on a firewall and testing false positive rates/false negative rates for known malicious/benign traffic corresponding to the test case. If a sufficient number of generated signatures fail regression and/or traffic testing, the signature generation system updates the signature prompt schema and retests the updated signature prompt schema until the validation tests and traffic tests pass. Subsequently, the signature generation system deploys the signature prompt schema in combination with the LLM to generate/update cyberattack signatures. Using LLMs to generate context-based cyberattack signatures increases quality of the cyberattack signatures such that they can detect malicious payload variants that can be missed by generic use of predefined regular expressions.

### Example Illustrations

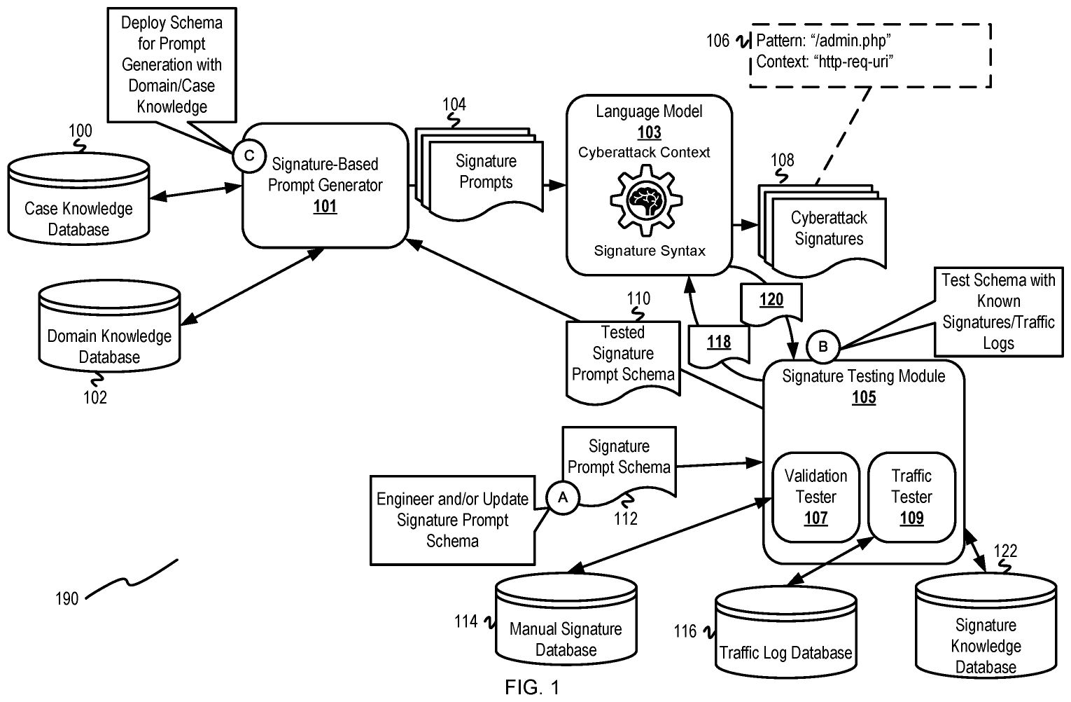

FIG. 1 is a schematic diagram of a context-based cyberattack signature generation system with a language model and a regression/traffic testing module. A context-based cyberattack signature generation system 190 comprises a signature testing module 105, a signature-based prompt generator 101, and a language model 103. The signature testing module 105 engineers and updates schema for generating signatures to prompt the language model 103 for cyberattack signature generation. The signature testing module 105 also tests engineered schema with validation testing and traffic testing for known/predefined test cases and deploys schema that pass the tests to the signature-based prompt generator 101. The signature-based prompt generator 101 generates prompts according to the deployed schema to generate/update cyberattack signatures using domain knowledge and case knowledge of types of cyberattacks corresponding to the cyberattack signatures.

FIG. 1 is annotated with a series of letters A-C that illustrate the development cycle for engineering and deploying signature prompt schema for generating prompts to the language model 103 for cyberattack signature generation. Each stage represents one or more operations. Although these stages are ordered for this example, the stages illustrate one example to aid in understanding this disclosure and should not be used to limit the claims. Subject matter falling within the scope of the claims can vary from what is illustrated. For instance, the context-based cyberattack signature generation system 190 can be deployed in a continuous integration/continuous delivery (CI/CD) development cycle to continuously engineer, update, and test signature prompt schema and to continuously update and test the language model 103 in combination with the signature prompt schema. Iterations of this development cycle as described by the operations at stages A-C can occur asynchronously.

At stage A, the signature testing module 105 engineers and/or updates a signature prompt schema 112 for deployment in combination with the language model 103. Engineering and/or updating of the signature prompt schema 112 can be due to lack of an existing signature prompt schema 112, an updated training of the language model 103, an accumulation of additional test cases, according to an update schedule, etc. Engineering/updating of the signature prompt schema 112 can be at least partly by a domain-level expert with prior knowledge of high-quality schema for generating prompts to LLMs. The domain-level expert can make alterations to previous signature prompt schema based on failed test cases, for instance by clarifying how to parse domain knowledge, clarifying syntax of the cyberattack signatures, etc.

At stage B, the signature testing module 105 tests the signature prompt schema 112 against stored test cases. The test cases are developed by a domain-level expert for known cyberattacks and corresponding domain knowledge, case knowledge, and minimum signature conditions for the known cyberattacks and data for the test cases is stored in a manual signature database 114, a traffic log database 116, and a signature knowledge database 122. For each test case, the signature testing module 105 (or, alternatively, the signature-based prompt generator 101) retrieves domain knowledge and case knowledge stored in databases and generates a prompt by inserting the domain knowledge and case knowledge into the signature prompt schema 112. This example depicts the signature testing module 105 as generating a prompt 118 by inserting the domain and case knowledge into the signature prompt schema 112. The signature testing module 105 communicates the prompt 118 to the language model 103 and the language model 103 responds with a cyberattack signature 120.

A validation tester 107 retrieves minimum signature conditions for the test case from a manual signature database 114 and determines whether the cyberattack signature 120 satisfies the minimum signature conditions. The minimum signature conditions define at least one pattern/context pair. The pattern/context pairs describe patterns that signatures detect in certain fields of packets for protocols (i.e., “context”). For instance, the minimum signature conditions can specify that a pattern “/example.aspx” be present in a HyperText Transfer Protocol (HTTP) field, that the pattern “‘; SELECT SLEEP (10);--” be present in a HTTP header field, etc. The validation tester 107 identifies the pattern/context pairs in the cyberattack signature 120 according to syntax of the cyberattack signature 120 described to the language model 103 by the prompt 118. For instance, the syntax can comprise a format such as JavaScript® Object Notation (JSON) format, YAML format, a proprietary/customizable format, etc.

A traffic tester 109 deploys the cyberattack signature 120 on a firewall (e.g., a firewall in a sandbox environment) to detect malicious/benign payloads in traffic with known malicious/benign payloads. The traffic comprises traffic specific to the type of cyberattack to be detected by the cyberattack signature, for instance for cyberattacks described in domain knowledge used to generate the prompt 118 such as blogs describing PoC code for the cyberattacks. The traffic tester 109 receives the known malicious/benign traffic payloads from the traffic log database 116. The malicious/benign traffic payloads can be stored as traffic logs (e.g., pcap files) that have already been logged by a firewall, and the cyberattack signature 120 can be deployed in a module of the firewall that handles traffic after it has already been logged. The traffic tester 109 then determines a false positive rate (“FPR”) and false negative rate (“FNR”) of malicious/benign verdicts by the firewall according to matches with the cyberattack signature 120 against ground truth malicious/benign verdicts for the traffic.

After validation testing and traffic testing, the signature testing module 105 determines whether the signature prompt schema 112 is ready for deployment (i.e., that the signature prompt schema 112 satisfies testing criteria) or that the signature prompt schema 112 is to be updated and retested. The testing criteria can indicate that the cyberattack signature 120 for each test case should satisfy the minimum signature conditions and the FPR and/or FNR should be above respective threshold rates. More lenient testing criteria, such as that a sufficient percentage of test cases satisfy the minimum signature conditions, can alternatively be implemented. If the signature testing module 105 determines the signature prompt schema 112 satisfies the testing criteria, the signature testing module 105 deploys it as a tested signature prompt schema 110 to the signature-based prompt generator 101.

At stage C, the context-based cyberattack signature generation system 190 deploys the tested signature prompt schema 110 in combination with the signature-based prompt generator 101 and the language model 103 for cyberattack signature generation. The signature-based prompt generator 101 communicates with a case knowledge database 100 and a domain knowledge database 102 to retrieve case knowledge and domain knowledge for types of cyberattacks to insert into the tested signature prompt schema 110 to generate signature prompts 104. The signature-based prompt generator 101 can receive notifications from the databases 100 and 102 as case/domain knowledge for additional and/or updated types of cyberattacks (i.e., additional/updated signatures) is stored. The databases 100 and 102 can crawl websites for known cybersecurity authorities (e.g., blogs, vulnerability descriptors, code databases) to generate/update case/domain knowledge for types of cyberattacks. The language model 103 receives the signature prompts 104 and generates cyberattack signatures 108 that comprise pattern/context pairs such as example pattern context pair 106 comprising a pattern “/admin.php” and a context “http-req-uri” indicating an HTTP Request-URI field where the pattern is located.

The case knowledge database 100 and domain knowledge database 102 can be built and maintained by crawling domains for known cybersecurity authorities (e.g., CVE® catalogs, popular cybersecurity blogs, code repositories for known exploits/vulnerabilities, etc.). The domain knowledge database 102 can be indexed by types of cyberattacks, for instance based on a keyword search of cyberattack identifiers such as vulnerability/exploit enumerations. Domain knowledge in the domain knowledge database 102 can be labelled based on type of content contained therein for each type of cyberattack (e.g., indications of a blog comprising PoC code, indication of types of code/scripts, etc.). The signature-based prompt generator 101 can query the case knowledge database 100 according to the content labels returned by the domain knowledge database 102 for a type of cyberattack and only insert case knowledge for those content labels into the tested signature prompt schema 110.

The language model 103 can be periodically updated/replaced by the context-based cyberattack signature generation system 190, for instance with a language model having more or fewer parameters based on operational constraints or a language model retrained on additional natural language data. For instance, the language model 103 can comprise a third-party LLM that is periodically updated based on release of updated model versions by the third-party developer. In response to updating/replacing the language model 103, the signature testing module 105 can retest the tested signature prompt schema 110 and, based on failure, engineer/update the tested signature prompt schema 110 as described at stage A and retest the engineered/updated schema as described at stage B.

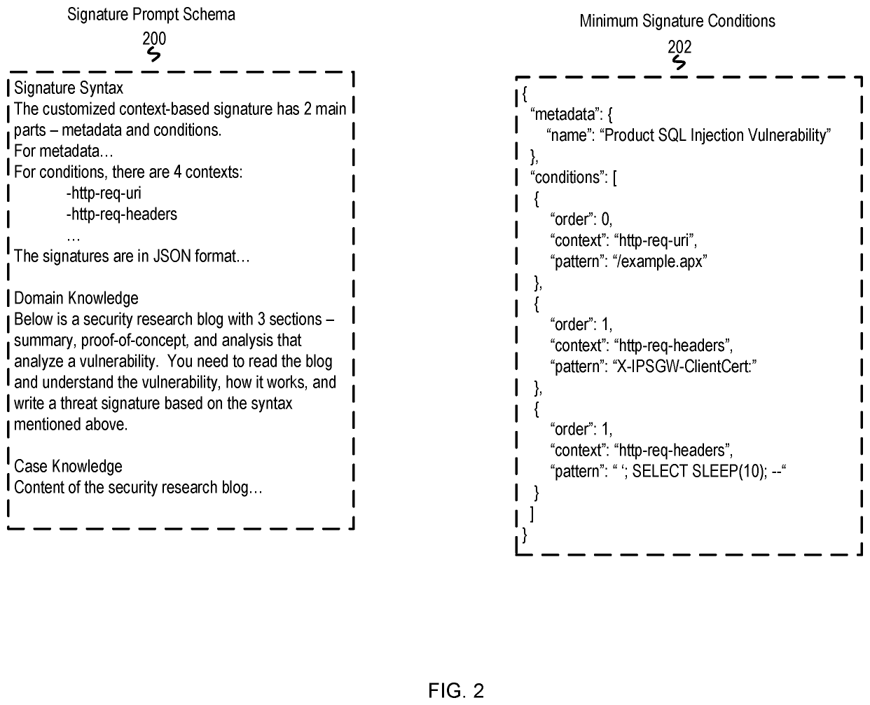

FIG. 2 is a diagram of an example signature prompt schema and example minimum signature conditions for a test case cyberattack signature. An example signature prompt schema 200 comprises:

### Signature Syntax

The customized context-based signature has 2 main parts-metadata and conditions.

### For Metadata . . .

For conditions, there are 4 contexts:
http-req-uri
http-req-headers
. . .

The signatures are in JSON format . . .

### Domain Knowledge

Below is a security research blog with 3 sections-summary, proof-of-concept, and analysis that analyze a vulnerability. You need to read the blog and understand the vulnerability, how it works, and write a threat signature based on the syntax mentioned above.

### Case Knowledge

### Content of the Security Research Blog . . .

The example signature prompt schema 200 comprises a first section having a syntax description for signatures such as what metadata to include in signatures, contexts to include conditions (e.g., patterns) in signatures, and format of the signatures. This informs a language model as to how to format signatures based on subsequent data. A second section describes what domain knowledge is included and how the language model should understand the domain knowledge in order to write a cyberattack signature. A third section indicates that case knowledge will describe content of the security research blog. The third section can further indicate formats of data in the security research blog such as a location of exploit or vulnerability code that the language model can parse for patterns, a location of analysis that will indicate flexibility in pattern scope for certain contexts, etc.

An additional example of domain knowledge for a cybersecurity report encoded in Extensible Markup Language (XML) is the following:

The given case_knowledge is a cybersecurity report in XML format. It has 2 sections-Identity and DetectionGuidance.

You will need to understand the report, extract the information for metadata from the Introduction section, and follow the defined signature syntax and the information from the DetectionGuidance to generate context-based threat signatures.

Case knowledge for this example is an XML cybersecurity report. The example XML cybersecurity report can comprise Uniform Resource Locators (URLs) and corresponding data crawled from those URLs for a type of cybersecurity attack. For instance, for SQL injection data can be crawled for CVE-2023-35036 and CWE-89. Metadata therein can comprise patterns corresponding to malicious entities for the cybersecurity attack type, severity levels for various fields such as attack severity, deployment, coverage, assets affected, etc.

Minimum signature conditions 202 for a test case signature comprise the following JSON data:

```
{
  “metadata”: {
      “name”: “Product SQL Injection Vulnerability”
  },
  “conditions”: [
    {
        “order”: 0,
        “context”: “http-req-uri”,
        “pattern”: “/example.apx”
    },
    {
        “order”: 1,
        “context”: “http-req-headers”,
        “pattern”: “X-IPSGW-ClientCert:”
    },
    {
        “order”: 1,
        “context”: “http-req-headers”,
        “pattern”: “ ‘; SELECT SLEEP(10); --“
    }
  ]
}
```

In the minimum signature conditions 202, the conditions are met when the patterns occur in the order present in a signature.

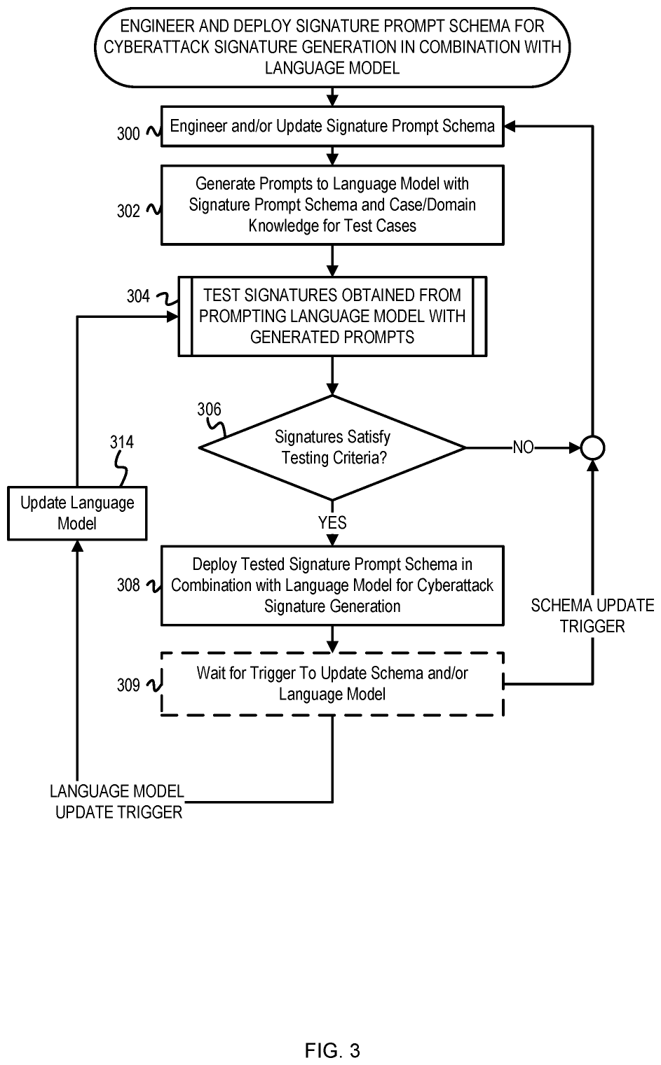

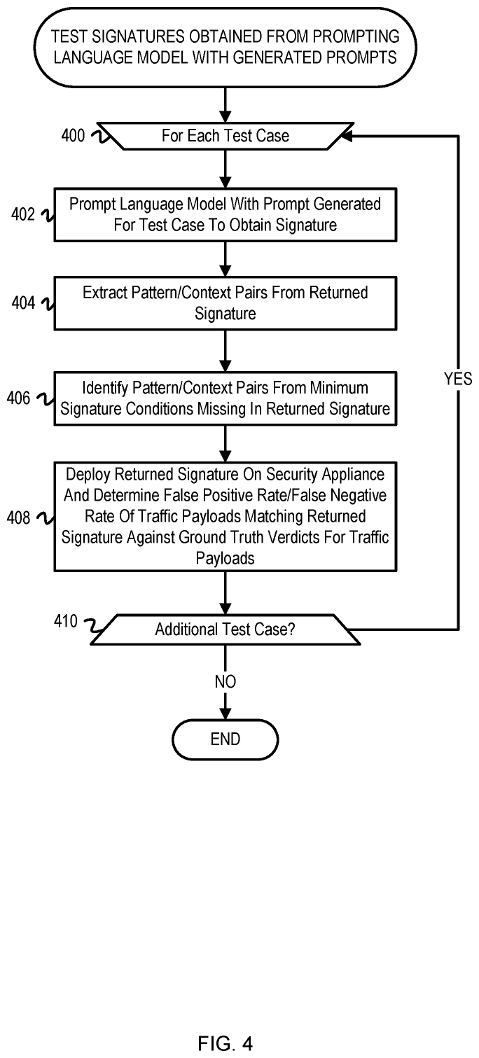

FIGS. 3-4 are flowcharts of example operations for generating and deploying a signature prompt schema in combination with a language model to generate cyberattack signatures with validation testing and traffic testing. The example operations are described with reference to a signature prompt schema, a language model, a signature-based prompt generator, and a signature testing module for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for engineering and deploying a signature prompt schema for cyberattack signature generation in combination with a language model. At block 300, a signature testing module engineers a signature prompt schema if no signature prompt schema has been previously engineered or updates a signature prompt schema that has previously been engineered. The signature prompt schema is designed to describe syntax for a cyberattack signature and to describe format and instructions involving case knowledge and domain knowledge for the cyberattack signature. The case knowledge and domain knowledge itself is omitted from the signature prompt schema, as this varies per cyberattack signature or type of cyberattack. In some embodiments, the signature testing module can generate multiple signature prompt schema corresponding to multiple types of domain knowledge and case knowledge, wherein the schema for each type of domain/case knowledge describes the types of domain/case knowledge included therein and instructions for how to understand the domain/case knowledge. Updating the signature prompt schema can comprise tuning descriptions for types of case/domain knowledge as well as the syntax based on failed testing. For instance, when a signature prompt schema has a high FPR on traffic testing, the signature prompt schema can be updated to clarify that patterns should be longer. When a signature prompt schema fails validation testing for certain types of cyberattacks, the signature prompt schema can be updated to more accurately describe domain knowledge specific to those types of cyberattacks (e.g., how to handle certain types of code or scripts related to those cyberattacks).

At block 302, the signature testing module generates prompts to the language model with the signature prompt schema and case/domain knowledge for test cases. For each test case, the signature testing module retrieves the case/domain knowledge for the test case from memory and inserts the case/domain knowledge into corresponding sections of the signature prompt schema to generate a prompt. The case/domain knowledge can be maintained in databases based on crawling domains for keywords associated with test cases (e.g., vulnerability/exploit identifiers). The case/domain knowledge can indicate types of data contained therein (e.g., whether it is a blog, PoC code, analysis, etc.) and the signature testing module can choose a signature prompt schema for those types of data for each test case prior to insertion of the case/domain knowledge.

At block 304, the signature testing module tests signatures obtained from prompting the language model with the generated prompts. The operations at block 304 are described in greater detail in reference to FIG. 4.

At block 306, the signature testing module determines whether the signatures obtained from prompting the language model satisfy testing criteria. For instance, the testing criteria can comprise the criteria that all or a threshold percentage of the validation test cases pass and/or that FPR and FNR for all or a threshold percentage of the traffic test cases are below respective thresholds. If the testing criteria are satisfied, operational flow proceeds to block 308. Otherwise, operational flow returns to block 300 for updating the signature prompt schema.

At block 308, the signature testing module deploys the tested signature prompt schema in combination with the language model for cyberattack signature generation. As case knowledge and domain knowledge is acquired for additional types of cyberattacks, a signature-based prompt generator inserts the domain knowledge and case knowledge into corresponding sections of the signature prompt scheme to generate prompts. The signature-based prompt generator then prompts the language model with the generated prompts to obtain cyberattack signatures in response. Subsequently, the cyberattack signatures are deployed on security appliances (e.g., cloud firewalls) for detection of malicious traffic payloads.

At block 309, the signature testing module waits for a trigger to update the signature prompt schema and/or update the language model. The trigger can comprise a triggering condition that an updated version of the language model is available, that additional test cases have been acquired for testing the signature prompt schema, etc. Block 309 is depicted with a dashed outline to indicate that triggers can occur asynchronously for the language model and the signature prompt schema. A trigger to update the language model can, upon completion of the update, prompt an additional trigger to update the signature prompt schema, and vice versa. If the signature testing module receives a language model update trigger, operational flow proceeds to block 314. If the signature testing module receives a schema update trigger, operational flow returns to block 300.

At block 314, the signature testing module (or other component/module) updates the language model, for instance by retraining the language model or replacing the language model with an updated version. Operation flow returns to block 304.

FIG. 3 depicts the example operations as being ongoing. In implementations, example operations may be complete if a termination criterion is satisfied, such as if neither updating the signature prompt schema nor updating the language model are triggered as described at block 309 within a designated length of time.

FIG. 4 is a flowchart of example operations for testing signatures obtained from prompting a language model with generated prompts. Validation testing and traffic testing are two example testing methodologies, and additional or alternative testing methodologies are additionally anticipated. For instance, cyberattack signatures can be tested on live traffic logs against existing cyberattack signatures for same types of attacks, patterns in cyberattack signatures can be analyzed for scope (e.g., patterns that are too long or too short), etc.

At block 400, a signature testing module begins iterating through test cases for testing cyberattack signatures. Each test case corresponds to a known type of cyberattack corresponding to a vulnerability/exploit for which there is verified case knowledge and domain knowledge as well as minimum signature conditions defining context/pattern pairs for signatures of the known type of cyberattack. Test cases can be periodically updated as additional knowledge is acquired for types of cyberattacks and as those types of cyberattacks adapt to newfound vulnerabilities/exploits. The signature testing module is preconfigured with a list of test cases and instructions for retrieving data for each test case.

At block 402 the signature testing module prompts a language model with a prompt generated for the test case to obtain a signature from the language model in response. The prompt was generated from a signature prompt schema with domain/case knowledge for the test case. The language model comprises any language model configured to output a cyberattack signature in response to the prompt. For instance, the language model can comprise an LLM, a lightweight generative language model, etc. The obtained signature has a syntax as described by the prompt, for instance a JSON file, YAML file, etc.

At block 404, the signature testing module extracts pattern/context pairs from the signature returned by the language model. The signature testing module extracts the pattern/context pairs according to a format of the signature specified by the syntax in the prompt. For instance, each entry of a JSON file within an array (e.g., a “pattern” or “pattern/context” array) can comprise a pattern/context pair.

At block 406, the signature testing module identifies pattern/context pairs from minimum signature conditions for the test case missing in the returned signature (if any). The signature testing module can perform an exact or approximate match of each of the pattern/context pairs in the minimum signature conditions with pattern/context pairs extracted from the returned signature to identify any pairs that are missing.

At block 408, the signature testing module deploys the returned signature on a security appliance, for instance a security appliance deployed in a sandbox environment for traffic testing. The signature testing module then tests the returned signature to determine a FPR and/or FNR on traffic payloads matching the returned signature against ground truth malicious/benign verdicts for the traffic payloads. The traffic payloads at least partially comprise malicious payloads corresponding to a type of cyberattack for the test case. At block 410, the signature testing module continues iterating through additional test cases. If there is an additional test case, operational flow returns to block 400. Otherwise, the operational flow in FIG. 4 terminates.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 402, 404, 406, and 408 can be performed in parallel or concurrently across test cases. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

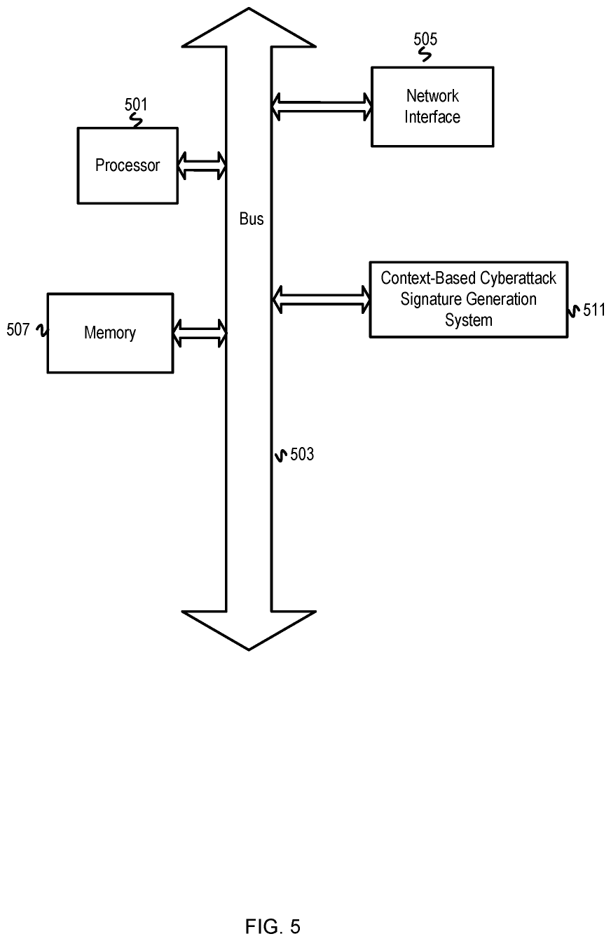

FIG. 5 depicts an example computer system with a context-based cyberattack signature generation system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a context-based cyberattack signature generation system (“signature generation system”) 511. The signature generation system 511 engineers signature prompt schema for generating prompts to a language model that responds to the prompts with cyberattack signatures. The signature prompt schema describes syntax for cyberattack signatures as well as case knowledge and domain knowledge for a corresponding type of cyberattack. The signature generation system 511 tests the engineered prompt schema by generating cyberattack signatures based on prompts to the language model generated according to the schema. The signature generation system 511 then tests the generated signatures against minimum signature conditions for known cyberattack signatures as well as against known malicious/benign traffic for the corresponding types of cyberattacks. If the signature prompt schema fails the testing, the signature generation system 511 updates and retests the signature prompt schema. Once the tests pass, the signature generation system 511 deploys the signature prompt schema in combination with the language model to generate cyberattack signatures based on domain knowledge and case knowledge for types of cyberattacks. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
generating a first syntax description, wherein the first syntax description describes syntax for cyberattack signatures to a language model;
testing the first syntax description based, at least in part, on at least one of previously generated cyberattack signatures and traffic logs;
generating a prompt to the language model with the first syntax description, first data for a type of cyberattack, and second data describing context of the first data for the type of cyberattack; and
prompting the language model with the prompt to obtain a cyberattack signature in response.

2. The method of claim 1, wherein testing the first syntax description comprises,
generating one or more prompts to the language model, wherein generating each prompt of the one or more prompts comprises generating the prompt with the first syntax description, data for a corresponding type of cyberattack, and data describing context of data for the corresponding type of cyberattack;
prompting the language model with the one or more prompts to obtain one or more cyberattack signatures in response; and
at least one of,
testing the one or more cyberattack signatures against previously generated signatures for the corresponding types of cyberattacks, and
testing the one or more cyberattack signatures against traffic logs for the corresponding types of cyberattacks.

3. The method of claim 2, wherein testing the one or more cyberattack signatures against previously generated signatures for the corresponding types of cyberattacks comprises determining whether each of the one or more cyberattack signatures satisfies minimum conditions for corresponding ones of the previously generated signatures.

4. The method of claim 3, wherein the minimum conditions comprise defined pattern and context pairs for each of the previously generated signatures.

5. The method of claim 2, wherein testing the one or more cyberattack signatures against traffic logs for the corresponding types of cyberattacks comprises determining at least one of a false positive rate and a false negative rate of malicious detections for each of the one or more cyberattack signatures on traffic logs of corresponding types of cyberattacks.

6. The method of claim 1, further comprising, based on a determination that the first syntax description fails the testing,
updating the first syntax description to a second syntax description;
testing the second syntax description based, at least in part, on at least one of the previously generated cyberattack signatures and the traffic logs; and
based on determining that the second syntax description passed the testing, deploying the second syntax description for generating prompts to the language model.

7. The method of claim 1, wherein the cyberattack signature indicates at least one context and at least one pattern, wherein the context comprises one or more fields in a protocol.

8. The method of claim 1, wherein the language model comprises a large language model.

9. A non-transitory machine-readable medium having program code stored thereon, the program code comprising instructions to:
generate a syntax description, wherein the syntax description describes syntax for cyberattack signatures to a language model;
generate a cyberattack signature based, at least in part, on the syntax description and data for a corresponding type of cyberattack;
test the cyberattack signature for malicious detection of the corresponding type of cyberattack; and
based on determining that the cyberattack signature passed the testing, deploy the syntax description in combination with the language model to generate cyberattack signatures of additional types of cyberattacks.

10. The non-transitory machine-readable medium of claim 9, wherein the program code to test the syntax description comprises instructions to:
generate one or more prompts to the language model, wherein generating each prompt of the one or more prompts comprises generating the prompt with the syntax description, data for the corresponding type of cyberattack, wherein the data for the corresponding type of cyberattack comprises data for context of the data for the corresponding type of cyberattack;
prompt the language model with the one or more prompts to obtain one or more cyberattack signatures in response; and
at least one of,
test the one or more cyberattack signatures against previously generated signatures for the corresponding types of cyberattacks, and
test the one or more cyberattack signatures against traffic logs for the corresponding types of cyberattacks.

11. The non-transitory machine-readable medium of claim 10, wherein the program code to test the one or more cyberattack signatures against previously generated signatures for the corresponding types of cyberattacks comprises instructions to determine whether each of the one or more cyberattack signatures satisfies minimum conditions for corresponding ones of the previously generated signatures.

12. The non-transitory machine-readable medium of claim 11, wherein the minimum conditions comprise defined pattern and context pairs for each of the previously generated signatures.

13. The non-transitory machine-readable medium of claim 11, wherein the program code to deploy the syntax description in combination with the language model to generate cyberattack signatures of additional types of cyberattacks comprises program code to,
generate one or more prompts for corresponding one or more of the additional types of cyberattacks based, at least in part, on the syntax description and data for corresponding ones of the one or more of the additional types of security attacks; and
prompt the language model with the one or more prompts to obtain the cyberattack signatures in response.

14. The non-transitory machine-readable medium of claim 9, wherein the cyberattack signature indicates at least one context and at least one pattern, wherein the context comprises one or more fields in a protocol.

15. The non-transitory machine-readable medium of claim 9, wherein the language model comprises a large language model.

16. An apparatus comprising:
a processor; and
a machine-readable medium having instructions stored thereon that are executable by the processor to cause the apparatus to:
generate a syntax description, wherein the syntax description describes syntax for cyberattack signatures to a language model;
generate a cyberattack signature based, at least in part, on the syntax description and indication of a type and description of context of a cyberattack;
test the cyberattack signature for malicious detection of the corresponding type of cyberattack; and
based on determining that the cyberattack signature passed the testing, prompt the language model with one or more prompts to generate one or more additional cyberattack signatures for one or more additional types of cyberattacks, wherein each of the one or more prompts comprises indications of the syntax description and data for corresponding ones of the one or more additional types of cyberattacks.

17. The apparatus of claim 16, wherein the instructions to test the syntax description comprise instructions executable by the processor to cause the apparatus to,
generate one or more prompts to the language model, wherein generating each prompt of the one or more prompts comprises generating the prompt with the syntax description, data for the corresponding type of cyberattack, wherein the data for the corresponding type of cyberattack comprises data for context of the data for the corresponding type of cyberattack;
prompt the language model with the one or more prompts to obtain one or more cyberattack signatures in response; and
at least one of,
test the one or more cyberattack signatures against previously generated signatures for the corresponding types of cyberattacks, and
test the one or more cyberattack signatures against traffic logs for the corresponding types of cyberattacks.

18. The apparatus of claim 17, wherein the instructions to test the one or more cyberattack signatures against previously generated signatures for the corresponding types of cyberattacks comprise instructions executable by the processor to cause the apparatus to determine whether each of the one or more cyberattack signatures satisfies minimum conditions for the corresponding ones of the previously generated signatures.

19. The apparatus of claim 18, wherein the minimum conditions comprise defined pattern and context pairs for each of the previously generated signatures.

20. The apparatus of claim 16, wherein the cyberattack signature indicates at least one context and at least one pattern, wherein the context comprises one or more fields in a protocol.
